(19) United States
(12) Patent Application Publication
(10) Pub. No.: US 2014/0175160 A1
(43) Pub. Date: Jun. 26, 2014

(54) SOLDER PASTE MATERIAL TECHNOLOGY FOR ELIMINATION OF HIGH WARPAGE SURFACE MOUNT ASSEMBLY DEFECTS

(71) Applicants: Rajen S. Sidhu, Chandler, AZ (US); Mukul P. Renavikar, Chandler, AZ (US); Ashay A. Dani, Chandler, AZ (US); Martha A. Dudek, Chandler, AZ (US)

(72) Inventors: Rajen S. Sidhu, Chandler, AZ (US); Mukul P. Renavikar, Chandler, AZ (US); Ashay A. Dani, Chandler, AZ (US); Martha A. Dudek, Chandler, AZ (US)

(21) Appl. No.: 13/725,279

(22) Filed: Dec. 21, 2012

(51) Int. Cl. B23K 1/20; B23K 35/24; B23K 35/362

(52) U.S. Cl. CPC B23K 1/203; B23K 35/362; B23K 35/24
USPC 228/224; 148/23; 148/24

(57) ABSTRACT

A composition including a solder flux including a rosin material have a property to maintain a less than 10 percent drop in tackiness from an initial tackiness value of 20 gf to 120 gf over a temperature regime of 20° C. to 200° C. A composition including a solder powder; and a solder flux including a rosin material including a softening temperature of 150° C. to 200° C. and a molecular weight of 300 g/mol to 600 g/mol. A method including introducing a solder paste to one or more contact pads of a substrate, the solder paste including a solder powder and a solder flux including a rosin material including a softening temperature of 150° C. to 190° C. and a molecular weight of 300 g/mol to 600 g/mol; contacting the solder paste with a solder ball of a package substrate; and heating the solder paste.

### FIELD

Integrated circuit mounting.

### BACKGROUND

Surface mount technology is a method for configuring electronic circuits in which components are mounted directly onto a surface of a substrate typically a printed circuit board (PCB). One technique involves ball grid array (BGA) packaging in which an integrated circuit package is used to mount devices such as a microprocessor to a printed circuit board through soldering. Electrical signals from the circuit device to the printed circuit board may be connected through balls of solder stuck to the bottom of the package. These solder balls are connected to contact pads on the printed circuit board by placing the solder balls in contact with respective ones of the contact pads and heating the structure to reflow the solder. One technique involves applying a paste that is a mixture of solder powder and a solder flux to the contact pads of the printed circuit board and then contacting the solder balls of the package to the paste followed by a reflow process. The solder ball and the solder powder of the paste join together in a common solder bond.

One issue that has arisen with the thermal connection of a BGA package to a printed circuit board is warpage of the package and/or board in response to the thermal process to heat the solder to a sufficient reflow temperature. It is believed that the package and possibly the printed circuit board warp in the presence of such heat because of coefficient of thermal expansion mismatches associated with the different layers of the package and/or board.

The warpage of the package and/or board can cause the solder balls of a package to separate from the contact pad to which it is aligned. The separation becomes problematic when the paste, that was originally on the pad, itself pulls away from the pad with the solder ball. With a tin (Sn) faced solder ball and a tin (Sn) solder powder in the solder paste, the solder paste tends to favor adhering to the solder ball over a contact pad of a different material (e.g., a copper contact pad). Upon heating, this can lead to what is referred to as a non-wet open (NWO) solder joint defect observed after reflow. With halogen free solder paste, NWO defects can be particularly high (e.g., as high as or greater than 80 percent yield loss), due to a general decrease in the aggressiveness of the fluxing action to remove surface oxides from solder metal.

### BRIEF DESCRIPTION OF THE DRAWINGS

FIG. 1 illustrates a representative reflow profile.

FIG. 2 illustrates a side view of a contact between a solder ball of a package and a contact pad of a printed circuit board and shows the effect of solder paste in response to warpage of one or both of the package and the board.

FIG. 3 illustrates a computing device in accordance with one implementation.

### DETAILED DESCRIPTION

Solder paste is generally a mixture of a solder powder and solder flux. Solder flux is generally made with rosin or resin, activators, viscosity controlling additives, chemicals, stabilizers and solvents. It has been determined that the tendency of solder paste to release from a contact pad in favor of adhering to a solder ball is affected by a tackiness, measured in grams-force (gf) units, of the solder flux. At temperatures necessary to heat the solder paste to reflow the solder, the prior art solder flux and consequently the prior art solder paste decrease in tackiness. As the solder paste loses its tackiness or softens, the solder paste will tend to lose its adherence for a contact pad and separate or pull away with the separating solder ball. Generally, the fluxing agents will remove the oxides present on the solder balls sooner in the processing cycle relative to the contact pads, leading to better adhesion to the solder balls, causing preferential separation from the contact pads.

A representative temperature range for a solder reflow process is a range from room temperature to 250° C.-270° C. Upon warpage, it has been determined that separation happens in a temperature range on the order of 120° C. to 190° C. which corresponds to a typical flux activation temperature. It has been found that if the solder paste can maintain its tackiness at least through a portion of the flux activation temperature, the paste will resist a tendency to separate or pull away from a contact pad in the presence of warpage, as the fluxing agent will have sufficient physical contact with the contact pad to allow the oxides to be removed and a joint to form.

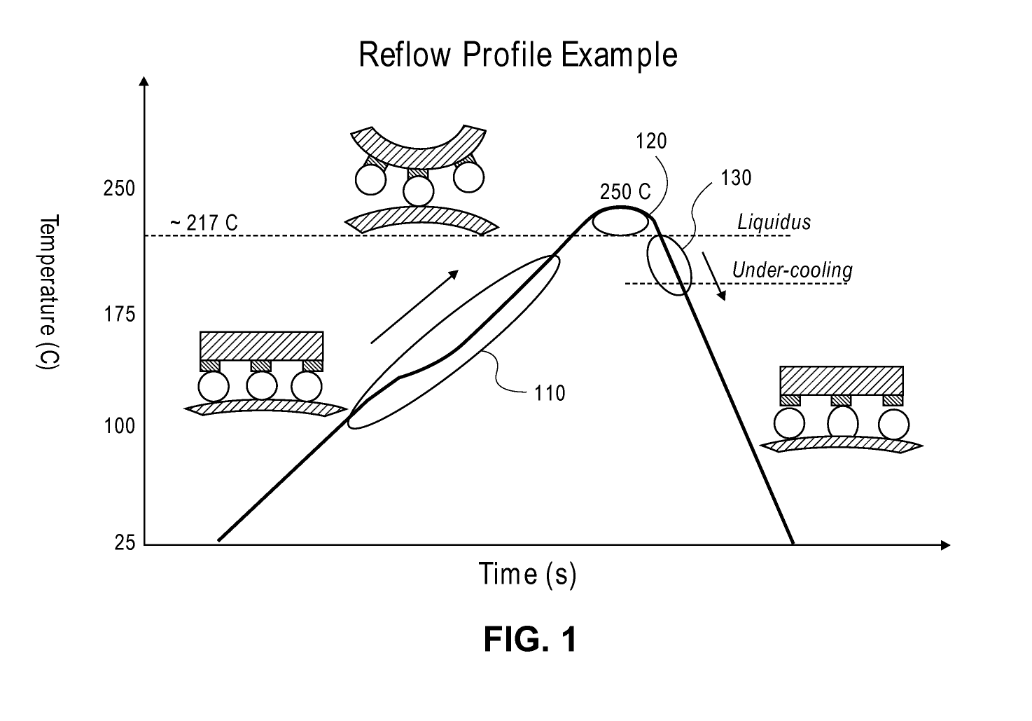

FIG. 1 illustrates a representative reflow profile. As shown in FIG. 1, heat is gradually applied to solder (i.e., to the structure including the package and circuit board). At a temperature range on the order of 120° C. to 190° C., a flux activation temperature (indicated at region 110) is reached where the components of the flux begin oxidation reduction on contact pads of the circuit board. It is also a temperature range where warpage of one of a package and/or a printed circuit board can experience warpage resulting in a separation distance between solder balls of a package and respective contact pads/paste of a printed circuit board. As the temperature is further increased, the liquidus of the solder paste is reached. The liquidus is the lowest temperature at which the alloy is completely molten. The solder remains in the fully liquid or molten state at temperatures above the liquidus (indicated at region 120). It is at this point, that the flux generally reduces surface tension at the juncture of the metals to accomplish metallurgical bonding, allowing the individual solder powder spheres to combine. A representative amount of time above liquidus is less than 60 seconds. At that point, the solder and structure is gradually cooled (indicated initially by region 130).

Accordingly, in one embodiment, a solder paste is disclosed that seeks to maintain a tackiness through at least a portion of a flux activation temperature range. The property of tackiness in a solder paste is primarily the contribution of a rosin material in the solder flux of the paste. Thus, one way to maintain tackiness of a solder paste through at least a portion of the flux activation temperate range is through a solder flux that includes a rosin material having a property to maintain a less than ten percent drop in tackiness from an initial tackiness value of 20 gram-force (gf) to 120 gf over a temperature regimen of 20° C. to 200° C.

In one embodiment, a tackiness of a solder flux is determined by the temperature (softening temperature) at which secondary bonds between cross-linked chains in the flux (in the rosin or resin of the flux) break and cause the flux to spread and drop in tackiness. In one embodiment, in rosin material selected for a solder flux includes a softening temperature of 150° C. to 190° C. By modulating the softening temperature and a molecular weight of a rosin or resin mixture, a tackiness of the solder flux may be maintained over a temperature range associated with a flux activation temperature where a solder paste might otherwise separate from a contact pad in the presence of warpage of the package and/or board.

In one embodiment, a solder flux includes one or more rosins that have a molecular weight in the range of 300 g/mol to 600 g/mol. Representative rosins include, but are not limited to, rosin esters, hydrogenated rosin resins, dimerized rosin resins and modified rosin resins. One particular class of rosins is phenolic modified rosin resins. Representative of this class are phenolic modified rosin esters including Pentalyn™ 793 HV-M resin, commercially available from Eastman.

In one embodiment, a solder flux includes 10 percent to 80 percent by weight of a rosin material. A suitable flux includes one that is a mixture of the rosin with additional raw materials including, but not limited to, one or more of organic acids, amines, solvents, activators and other additives. Suitable organic acids include, but are not limited to, mono-, di-, tri-carboxylic acid having between two and 20 carbon atoms. Examples of suitable organic acids include, but are not limited to, glycolic acid, oxalic acid, succinic acid, malonic acid and the like or their combinations. Suitable amines include primary, secondary and tertiary amines including four to 20 carbon atoms. Representative examples of suitable amines include, but are not limited to, butyl amine, diethylbutyl amine, dimethylhexyl amine and the like or their combinations. Suitable solvents include a wide variety of solvents as known in the solder flux industry. Suitable activators include halogenated and non-halogenated activators.

In one embodiment, a composition of a solder paste includes a mixture of a flux such as described and solder powder. A representative range for solder flux in such a mixture is on the order of 10 weight percent to 40 weight percent and for solder power 60 weight percent to 90 weight percent. The solder powder can include solder metal, including metal alloys, having particle sizes ranging from 30 nanometers to 50 micrometers. Representative alloys include tin-rich alloys such as Sn—XAg—XCu, Sn—XCu, Sn—XAg. Other low melting point powders can be included that encompass a reflow temperature in the range of 150° C. to 300° C.

A paste composition such as described will provide a temperature stable tackiness ranging from 20 gf to 120 gf, with a change in tackiness of less than 10 percent over a temperature range of 20° C. to 200° C.

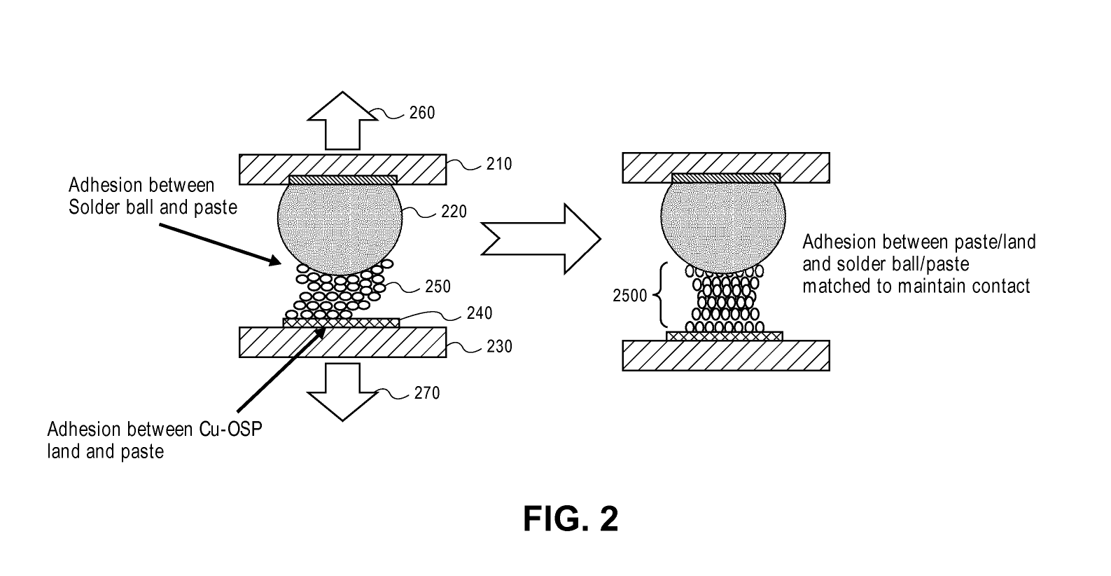

FIG. 2 shows an illustration of the contact between a solder ball of, for example, a BGA package and a contact pad of a printed circuit board in the presences of warpage of one or both of the package and the board. FIG. 2 shows a portion of package 210 including solder ball 220 connected to a contact pad of the package. Solder ball 220 includes, for example, an Sn-type solder material. FIG. 2 also shows printed circuit board 230 including contact pad 240 on a surface thereof. In one embodiment, contact pad 240 is a copper material. Overlying a surface of contact pad 240 is, for example, an organic surface protectant (OSP) that protects a material of a contact pad from oxidation. The OSP will burn off during reflow. Overlying contact pad 240 is solder paste 250 that, in this embodiment, includes an Sn-type solder powder.

Prior to solder reflow, solder ball 220 of package 210 is brought into contact with solder paste 250. During solder reflow, one or both of package 210 and printed circuit board 230 can warp. Warpage can cause solder ball 220 to separate from the solder paste 250 and contact pad 240. The separation force is indicated by arrows 260 and 270. Because solder paste 250 includes an Sn-type solder powder, the solder paste will favor adherence to solder ball 220. Where solder paste 250 is a material such as described above, with, for example, sufficient tackiness through at least a portion of the paste activation temperature, a portion of solder paste 250 may pull away from contact pad 240 in response to separation forces (arrows 260 and/or 270), but the adhesion of the paste to contact pad 240 can be maintained (and preferably matched to the adhesion between solder paste 250 and solder ball 220) as indicated in the illustration on the right side of the figure where a profile of solder paste 250 shows matched adhesion of adhesion of the paste between solder paste 250 and solder ball 220.

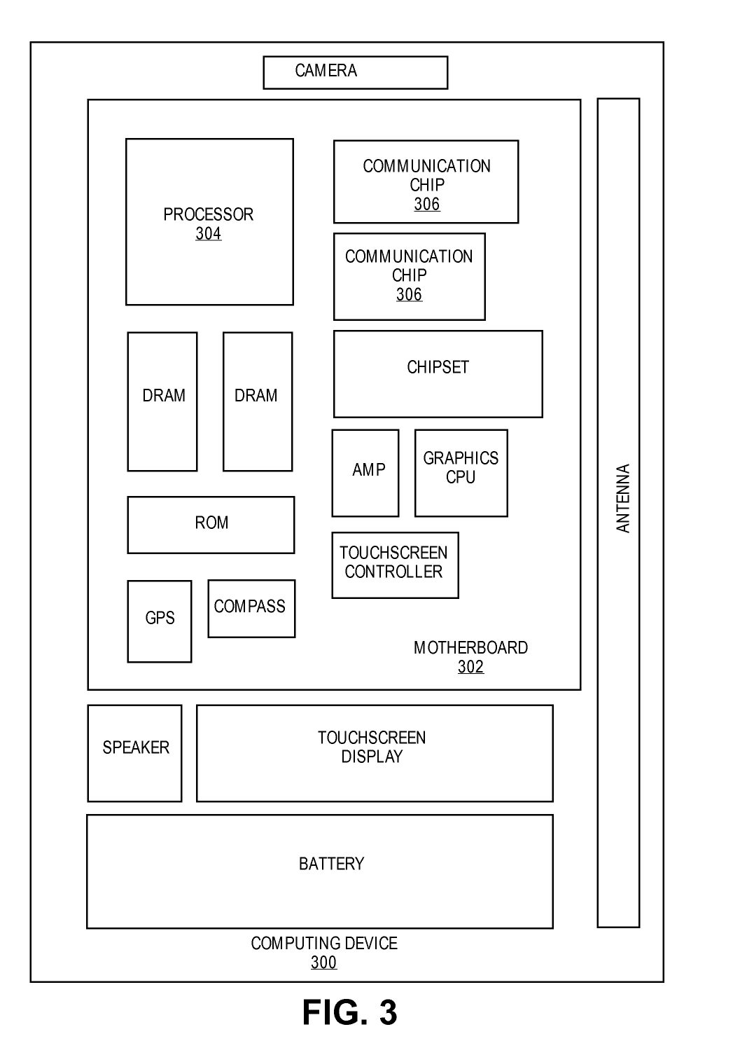

FIG. 3 illustrates a computing device in accordance with one implementation. Computing device 300 houses board 302. Board 302 may include a number of components, including but not limited to processor 304 and at least one communication chip 306. The term “processor” may refer to any device or portion of a device that processes electronic data from registers and/or memory to transform that electronic data into other electronic data that may be stored in registers and/or memory. Processor 304 of computing device 300 includes an integrated circuit die in a package, such as a BGA package. Processor 304 is physically and electrically connected to board 302 through for example, a BGA package wherein solder balls of the package are connected to contact pads of the board using the solder paste and process described above. In some implementations at least one communication chip 306 is also physically and electrically connected to board 302 optionally in a similar manner. In further implementations, communication chip 306 is part of processor 304.

Depending on its applications, computing device 300 may include other components that may or may not be physically and electrically coupled to board 302. These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth).

Communication chip 306 enables wireless communications for the transfer of data to and from computing device 300. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. Communication chip 306 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. Computing device 300 may include a plurality of communication chips 306. For instance, a first communication chip 306 may be dedicated to shorter range wireless communications such as Wi-Fi and Bluetooth and a second communication chip 306 may be dedicated to longer range wireless communications such as GPS, EDGE, GPRS, CDMA, WiMAX, LTE, Ev-DO, and others.

In further implementations, another component housed within computing device 300 may contain a microelectronic package incorporates a primary core surrounding a TSV or non-TSV integrated circuit die that inhibits package warpage.

In various implementations, computing device 300 may be a laptop, a netbook, a notebook, an ultrabook, a smartphone, a tablet, a personal digital assistant (PDA), an ultra mobile PC, a mobile phone, a desktop computer, a server, a printer, a scanner, a monitor, a set-top box, an entertainment control unit, a digital camera, a portable music player, or a digital video recorder. In further implementations, computing device 300 may be any other electronic device that processes data.

In the description above, for the purposes of explanation, numerous specific details have been set forth in order to provide a thorough understanding of the embodiments. It will be apparent however, to one skilled in the art, that one or more other embodiments may be practiced without some of these specific details. The particular embodiments described are not provided to limit the invention but to illustrate it. The scope of the invention is not to be determined by the specific examples provided above but only by the claims below. In other instances, well-known structures, devices, and operations have been shown in block diagram form or without detail in order to avoid obscuring the understanding of the description. Where considered appropriate, reference numerals or terminal portions of reference numerals have been repeated among the figures to indicate corresponding or analogous elements, which may optionally have similar characteristics.

It should also be appreciated that reference throughout this specification to “one embodiment”, “an embodiment”, “one or more embodiments”, or “different embodiments”, for example, means that a particular feature may be included in the practice of the invention. Similarly, it should be appreciated that in the description various features are sometimes grouped together in a single embodiment, figure, or description thereof for the purpose of streamlining the disclosure and aiding in the understanding of various inventive aspects. This method of disclosure, however, is not to be interpreted as reflecting an intention that the invention requires more features than are expressly recited in each claim. Rather, as the following claims reflect, inventive aspects may lie in less than all features of a single disclosed embodiment. Thus, the claims following the Detailed Description are hereby expressly incorporated into this Detailed Description, with each claim standing on its own as a separate embodiment of the invention.

1. A composition comprising:
a solder flux comprising a rosin material comprising a phenolic modified rosin resin comprising a softening temperature of 150° C. to 190° C. and a molecular weight of 300 g/mol to 600 g/mol and having a property to maintain a less than 10 percent drop in tackiness from an initial tackiness value of 20 gf to 120 gf over a temperature regime of 20° C. to 200° C.

2. (canceled)

3. The composition of claim 1, wherein the rosin material is present in an amount of 10 percent to 80 percent by weight of the solder flux.

4. The composition of claim 3, wherein the flux further comprises an activator having a property to disrupt or dissolve metal oxides.

5. The composition of claim 4, wherein the flux further comprises at least one of an organic acid, an amine, or a solvent.

6. (canceled)

7. A composition comprising
a solder powder; and
a solder flux comprising a rosin material comprising a phenolic modified rosin resin comprising a softening temperature of 150° C. to 190° C. and a molecular weight of 300 g/mol to 600 g/mol.

8. The composition of claim 7, wherein the rosin material is present in an amount of 10 percent to 80 percent by weight of the solder flux.

9. The composition of claim 7, comprising 60 percent to 90 percent by weight of the solder powder and 10 percent to 40 percent by weight of the solder flux.

10. The composition of claim 9, wherein the solder flux further comprises at least one of an activator, an organic acid, an amine, or a solvent.

11. (canceled)

12. A method comprising:
introducing a solder paste to one or more contact pads of a substrate, the solder paste comprising a solder powder and a solder flux comprising a rosin material comprising a phenolic modified rosin resin comprising a softening temperature of 150° C. to 190° C. and a molecular weight of 300 g/mol to 600 g/mol;
contacting the solder paste with a solder ball of a package substrate; and
heating the solder paste.

13. The method of claim 12, wherein the solder paste comprises 60 percent to 90 percent by weight of the solder powder and 10 percent to 40 percent by weight of the solder flux.

14. The method of claim 13, wherein the rosin material is present in an amount of 10 percent to 80 percent by weight of the solder flux.

15. The method of claim 12, wherein the solder flux further comprises at least one of an activator, an organic acid, an amine, or a solvent.

16. (canceled)
